(19) United States
(12) Patent Application Publication
(10) Pub. No.: US 2010/0070491 A1
(43) Pub. Date: Mar. 18, 2010

(54) Dynamic Contextual Table Headers

(75) Inventors: Brian J. Cragun, Rochester, MN (US); Douglas R. Fish, Rochester, MN (US); William H. Krebs, JR., Cary, NC (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 12/212,823

(22) Filed: Sep. 18, 2008

(51) Int. Cl. G06F 17/30

(52) U.S. Cl. 707/722; 707/E17.009

(57) ABSTRACT

Techniques are disclosed for presenting users with dynamic contextual table headers when viewing database records. The dynamic contextual table header may provide a title (or other relevant information) for some columns of the table. For example, database records may be displayed along with a header generated according to a particular context—typically a row of the table selected by a user.

### BACKGROUND OF THE INVENTION

1. Field of the Invention

Embodiments of the invention generally relate to presenting information to a user in a useful manner. More specifically, embodiments of the invention relate to a method for presenting dynamic contextual table headers.

2. Description of the Related Art

Tables are commonly used as means for both a mode of visual communication and a means of arranging data. The use of tables is pervasive throughout all communication, research, and data analysis. Tables appear in print media, handwritten notes, computer software, and many other places. The precise conventions and terminology for describing tables varies depending on the context. Moreover, tables can differ significantly in variety, structure, flexibility, notation, representation and use.

Generally, a table includes an ordered arrangement of rows and columns. Often times, rows may be referred to as a record, k-tuple, n-tuple, or a vector, while columns may be referred to as a field, parameter, property, or an attribute. Additionally, a column may be displayed with a name or header, which provides context for the data stored in a column. The header may provide a word, phrase, or a numerical index.

In some cases, a table may be organized where not every column is used by each given row. That is, the records in a table may not include a data value for each column. A table organized in this manner results in empty cells (or fields). As a result, information contained for a given row may be sparse, which may make readability difficult. In addition, readability may suffer as data spreads beyond the number of columns that can be seen at one time because of the size of the display, viewing window, or printed paper.

### SUMMARY OF THE INVENTION

One embodiment of the invention includes a computer-implemented method of presenting data records. The method may generally include displaying a plurality of records in a table. The table may include a plurality of columns. Additionally, each record is displayed in a row of the table and may include data values for one or more of the columns of the table. The method may also include receiving a selection of one of the records of the table and identifying which columns of the selected record include data values. The method may also include generating a table header that includes each of the identified columns and displaying the table header.

Still another embodiment of the invention includes a computer-readable storage medium containing a program which, when executed, performs an operation for presenting a display of data records. The operation may generally include displaying a plurality of records in a table. Each table may include a plurality of columns. Additionally, each record may be displayed in a row of the table and includes data values for one or more of the columns of the table. The operation may also include receiving a selection of one of the records of the table and identifying which columns of the selected record include data values. The operation may also include generating a table header that includes each of the identified columns and displaying the table header.

Still another embodiment of the invention includes a system having a processor and a memory containing a program, which when executed by the processor, performs an operation for presenting a display of data records. The operation may generally include displaying a plurality of records in a table. Each table may include a plurality of columns. Additionally, each record may be displayed in a row of the table and includes data values for one or more of the columns of the table. The operation may also include receiving a selection of one of the records of the table and identifying which columns of the selected record include data values. The operation may also include generating a table header that includes each of the identified columns and displaying the table header.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a computing environment, according to one embodiment of the invention.

FIG. 2 illustrates a graphical user interface screen, which presents a set of records organized in a table, according to one embodiment of the invention.

FIGS. 3A-3C illustrate GUI screens which present a compacted table to a user, according to one embodiment of the invention.

FIG. 4 illustrates a GUI screen which presents a compacted table with duplicate column headers, according to one embodiment of the invention.

FIG. 5 illustrates a GUI screen which presents a compacted table with aligned common column headers, according to one embodiment of the invention.

FIG. 6 illustrates a GUI screen which presents a compacted table with aligned common column headers, according to another embodiment of the invention.

FIG. 7 is a flowchart illustrating a method for dynamically displaying contextual table headers, according to one embodiment of the invention.

### DETAILED DESCRIPTION OF THE PREFERRED EMBODIMENTS

Embodiments of the invention provide techniques for presenting users with dynamic contextual table headers when viewing database records. The table header may provide a title (or other relevant information) for some columns of the table. For example, database records may be displayed along with a header generated according to a particular context—typically a row of the table selected by a user. As different records may store data values for different sets of columns, the table-header generated for the user may change as different records of the table are selected. Further, the columns of the table may be compacted to present the user with only the columns relevant to a particular row. For example, a user may be presented with a table containing a plurality of selectable records. The data for a given record may be interspersed among the columns of the record. That is, some columns contain data for the record, while others remain empty. If a user selects a record, the table may be compacted to display only the column headers and columns relevant to the selected record. Additionally, as a user subsequently selects additional records, the table may be re-formatted to dynamically display the column headers relevant to the newly-selected record.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

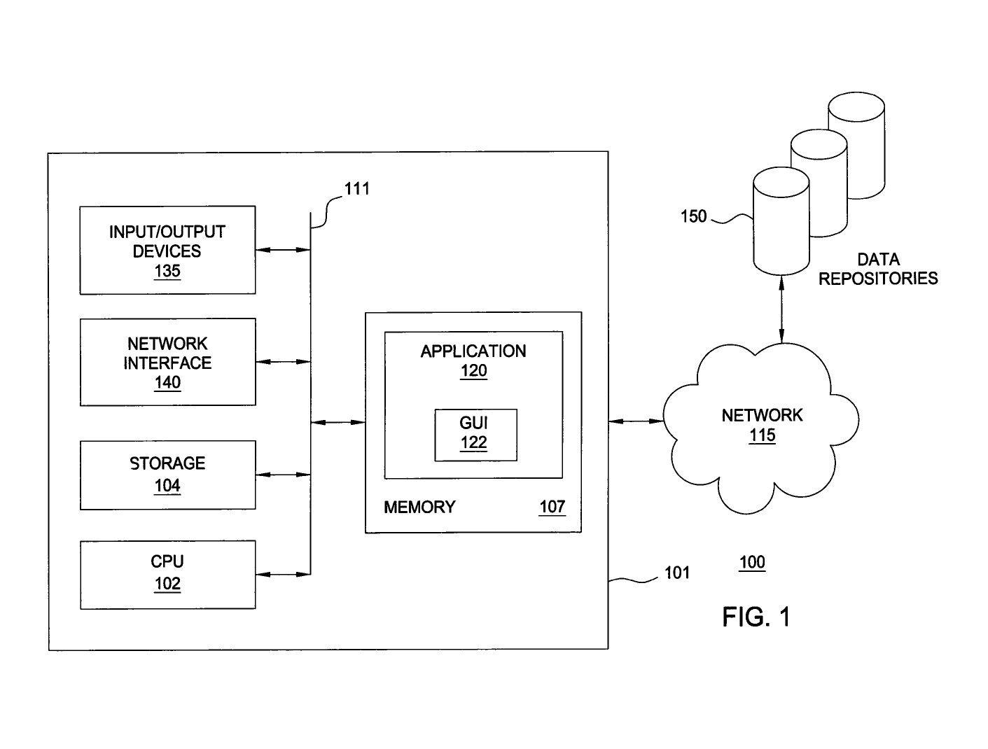

One embodiment of the invention is implemented as a program product for use with a computer system such as, for example, the computing environment 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

FIG. 1 is a block diagram illustrating a computing environment 100 according to one embodiment of the invention. As shown, a computer system 101 is included to be representative of existing computer systems, e.g., desktop computers, server computers, laptop computers, tablet computers, and the like. However, the computer system 101 illustrated in FIG. 1 is merely an example of a computing system. Embodiments of the present invention may be implemented using other computing systems, regardless of whether the computer systems are complex multi-user computing systems, such as a cluster of individual computers connected by a high-speed network, single-user workstations, or network appliances lacking non-volatile storage. Further, the software application(s) described herein may be implemented using computer software application(s) executing on existing computer systems. However, the software application(s) described herein are not limited to any currently existing computing environment or programming language, and may be adapted to take advantage of new computing systems as they become available.

As shown, computer system 101 includes a central processing unit (CPU) 102, which obtains instructions and data via a bus 111 from memory 107 and storage 104. CPU 102 represents one or more programmable logic devices that perform all the instruction, logic, and mathematical processing in a computer. For example, CPU 102 may represent a single CPU, multiple CPUs, a single CPU having multiple processing cores, and the like. Storage 104 stores application programs and data for use by computer system 101. Storage 104 may be hard-disk drives, flash memory devices, optical media and the like. Computer system 101 may be connected to a data communications network 115 (e.g., a local area network, which itself may be connected to other networks such as the internet).

Additionally, computer system 101 may include input/output devices 135 such as a mouse, an eye tracking device, a keyboard and monitor, as well as a network interface 140 used to connect computer system 101 to the network 115.

Memory 107 can be one or a combination of memory devices, including random access memory, nonvolatile or backup memory, (e.g., programmable or flash memories, read-only memories, etc.). As shown, memory 107 includes an application 120. In one embodiment, the application 120 provides a software application configured to request, receive, and present a set of data records to a user. For example, in response to a database query. In addition, the application 120 may also include a graphical user interface (GUI) 122. The GUI 122 may enable a user to view data records, provide an interface for a user to manipulate the data, and also modify how data records are presented to the user to include dynamic contextual table headers.

In one embodiment, application 120 may comprise a database front-end, or query application program running on computer system 101. The application 120 may be configured to allow a user to compose a query and to submit the query to a database for processing. In such a case, the application 120 may also display the query results received from the database. In another embodiment, application 120 may also be a spreadsheet program or a web-browser configured to interact with an application server. In any case, the set of records accessed and displayed by application 120 may be organized in a table format. For example, the table may display multiple cells that provide a grid of rows and columns, where some cells may contain data values (e.g., an integer, a character, a string, etc.), while other cells are empty.

Illustratively, computing environment 100 also includes a set of data repositories 150. In one embodiment, each data repository 150 may provide a source of records processed by the application 120. For example, in the case where the application 120 is a query application program, the data repositories 150 may serve as a database. In the case where the application 120 is a spreadsheet program, the data repositories 150 may serve as storage for the records held in the tables. In the case of a web browser, the repositories may include databases accessed through an application server. Of course, one of ordinary skill in the art will recognize that the records may also be stored locally in the storage 104 of the computer system 101.

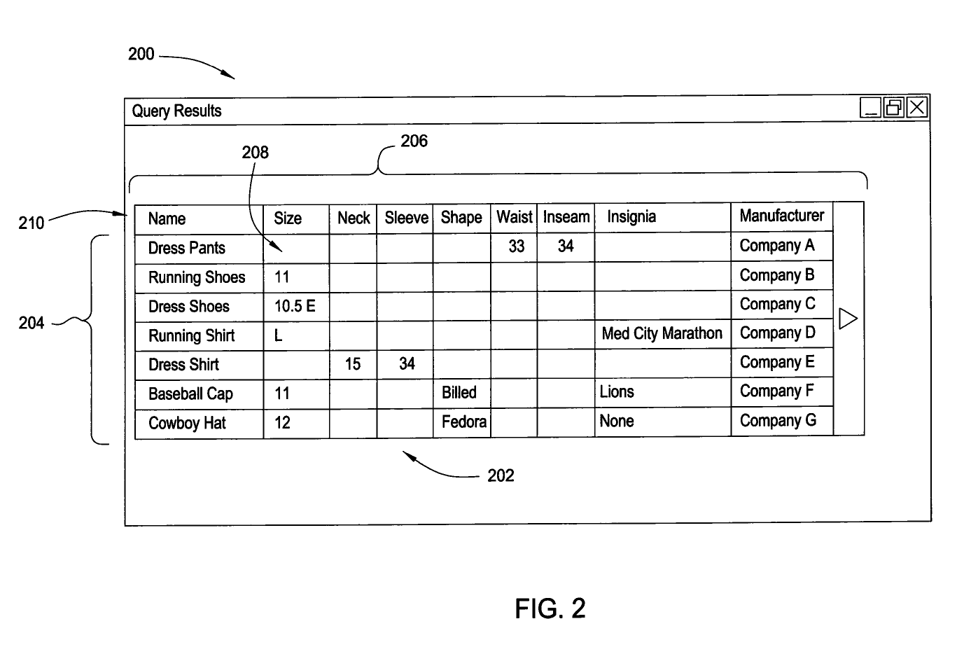

FIG. 2 illustrates a graphical user interface screen displaying a set of records organized in a table, according to one embodiment of the invention. As shown, the table 202 includes a plurality of cells 208, organized into rows 204 and columns 206. In one embodiment, a record may be defined as a row of cells, where each cell in the row represents an item in the record. To provide context for the items in a given column, the table 202 also includes column headers 210 located at the top of the columns. The contextual column headers 210 provide a descriptive label for the items stored in the cells 208 of a given column.

Illustratively, each row 204 of the table 202 represents a record containing a variety of information for different articles of clothing. As stated above, column headers 210 may be used to provide an indication of what information is stored by a given column. For example, the first column of the table 202 provides the name for an article of clothing, and is referenced by a column header of “Name.” The remaining columns each provide an attribute of the article of clothing such as “Size,” “Neck,” “Sleeve,” etc.

As shown, table 202 includes a plurality of attributes, which are not all relevant for each record (i.e., some attributes stored in table 202 are not relevant for certain items of clothing). Illustratively, the records in table 202 are more or less disjoint for different fields, depending on which row is being considered. For example, the record for a “Dress Shirt” includes values for a neck and sleeve size (as indicated by column headers of “Neck” and “Sleeve”), but does not include values for a waist size or an inseam (as the values under the column headers of “Waist” and “Inseam” are empty). On the other hand, a record for a “Dress Pant” does include values for a waist size and inseam, but does not include values for a neck and sleeve size. As a result, any single record in table 202 may include some empty cells (i.e. cells without a value). Accordingly, the empty cells may indicate that a particular attribute (or column) is not applicable (or irrelevant) for a given record.

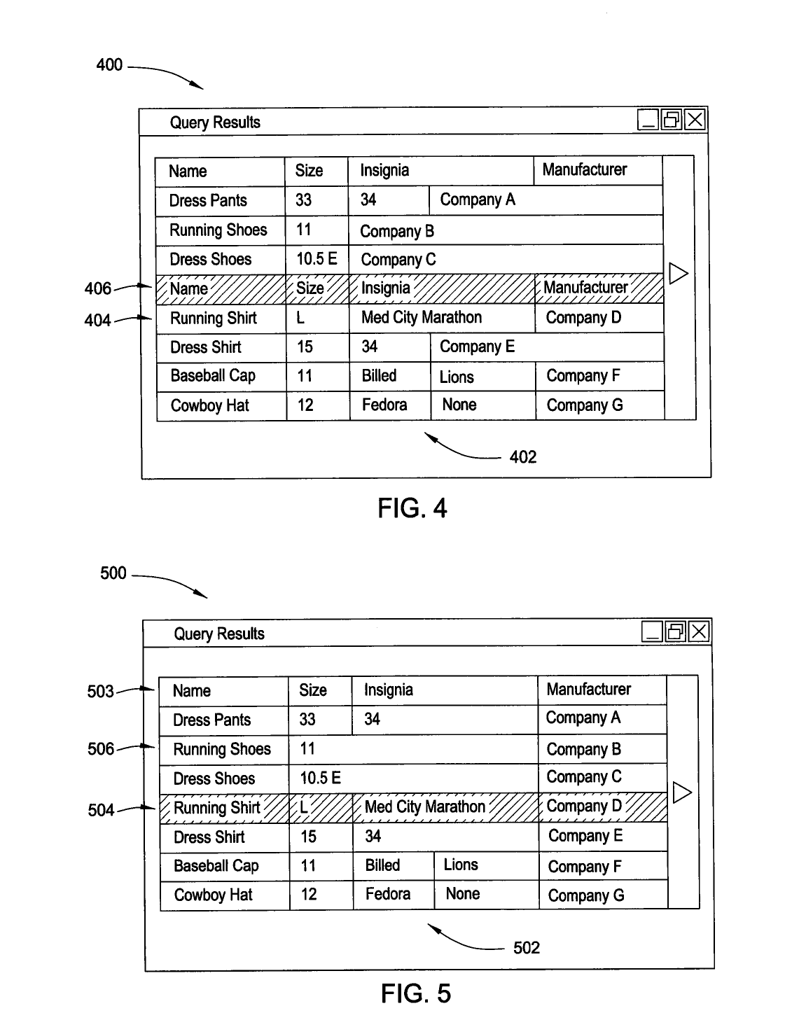

In one embodiment, the GUI 122 may enable a user to select a record from the table 202. For example, a user may use an input device 135, such as a mouse, to select a record. In such a case, the user may move a cursor over a particular record and click a mouse button to select the record. Alternatively, the user may simply “hover” a mouse cursor over a particular record to select the record. In another embodiment, a user may use an input device 135, such as an eye tracker, to select a record. The eye tracker device may determine the focus of a user's eye in relation to information displayed on a display monitor. Accordingly, when the user focuses on a particular record, that record may be selected. In one embodiment, a timing threshold may be provided that allows the eye to veer from the selected record into the column header or into a duplicate column header (as discussed below with reference to FIG. 4) without the selected record being deselected. Thus, a user using an eye tracker device may effectively see the data and the dynamic header without losing selection.

In one embodiment, once a record is selected, a compacted table may be generated which displays only the columns relevant to the selected record, and also removes the empty cells of the table 202. Alternatively, a compacted table may be created before the table is displayed and before any record is selected. In such a case, no column header is displayed until a record is selected. Further, as a user continues to select records from the table 202, the column headers 210 may dynamically change to reflect the context of the newly-selected record.

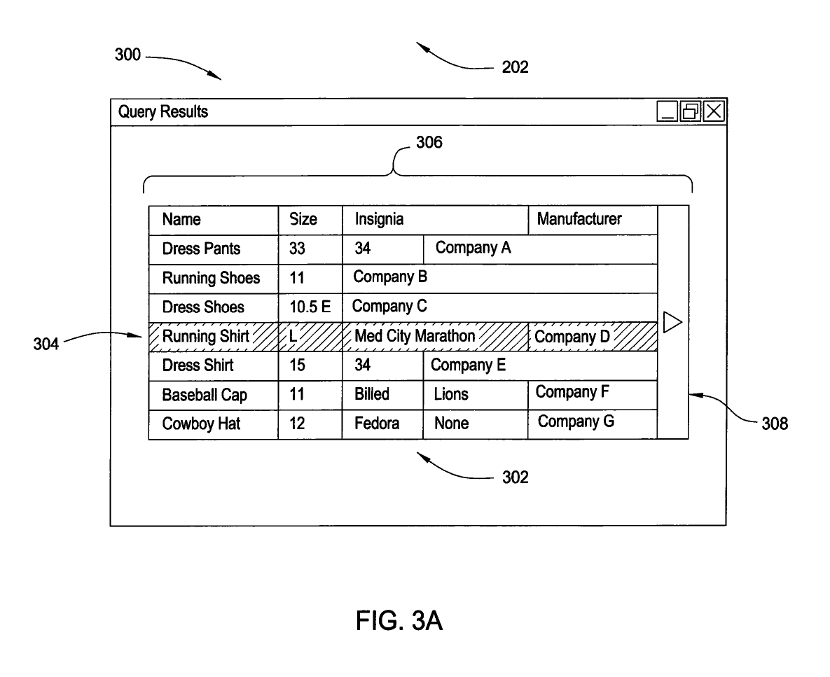

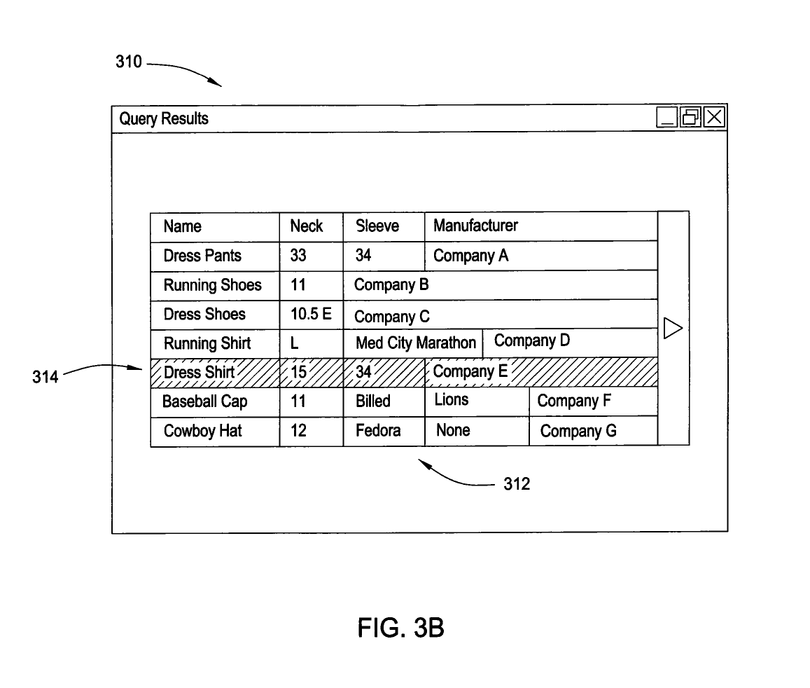

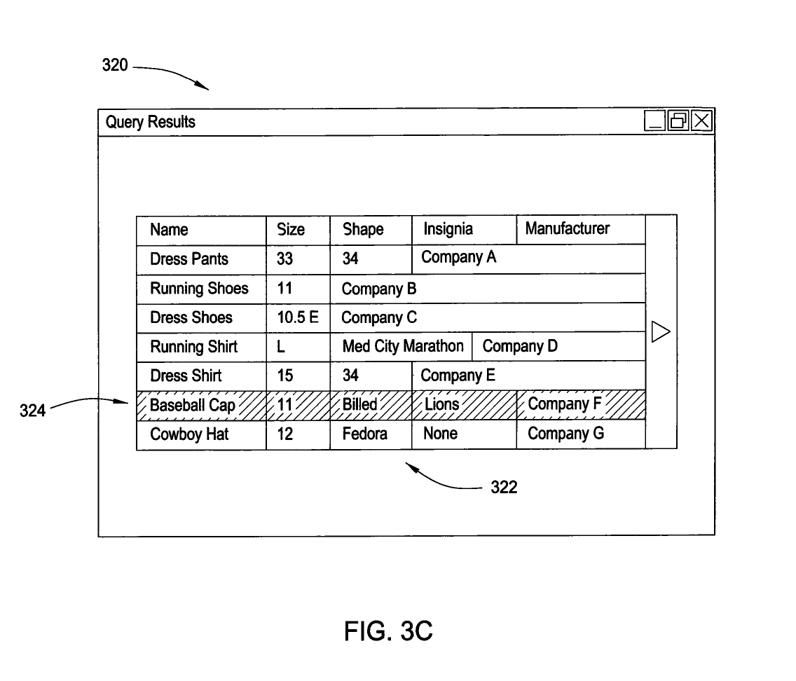

FIGS. 3A-3C illustrate GUI screens that include a dynamic contextual table generated header for a “Running Shirt” record of table 202, according to one embodiment of the invention. Illustratively, each screen represents a table generated from a user selection of a different record from table 202. For example, FIG. 3A illustrates a screen 300 displaying a compacted table 302 where the user has selected the record 304 for “Running Shirt.” The relevant columns for the record 304 (as illustrated in FIG. 2) are “Name,” “Size,” “Insignia,” and “Manufacturer.” Accordingly, as shown in FIG. 3A, the columns of table 302 have been reordered so that only these columns headers are displayed, and the columns containing empty cells for the record (e.g. “Neck,” “Sleeve,” “Shape,” “Waist,” and “Inseam”) are shown, but do not include a header. However, in one embodiment, only cells with headers are shown. Alternatively, all records in a table may be displayed in the same table, at the same time, and header information may be changed to match each row selected by a user. This allows records to be drawn from with from multiple disparate tables each with a limited set of data points and joined together using known relational database techniques. These disparate records are then displayed directly in a table. In such a case, a dynamic contextual table header may be generated dynamically in response to selections of individual rows.

In one embodiment, the GUI 122 may enable a user to view the columns removed from the “compacted” display. For example, when reordering the table, the table 302 may be reordered so that empty columns (relative to the selected record) are moved to one end of the record. Furthermore, the table 302 may be collapsed, so that only the relevant columns are displayed. To view the additional columns, the GUI 122 may include an “Uncollapse/Collapse” button 306 used to expand the table to display all the columns of the record. Once the table 300 is un-collapsed, the user may return to the collapsed view by again pressing the “Uncollapse/Collapse” button 306.

As stated earlier, compacted table 302 may remove the columns that are not relevant to a selected record from a display of that record. For example, unselected records may have values stored in the columns that are no longer displayed. In one embodiment, these values may be shifted into empty cells located under the column headers displayed for the selected record. Thus, not only are empty cells removed, but the values of the unselected records are preserved such that the user can see the data about unselected record instead of empty cells.

As an example, consider the record for “Dress Pant” of FIG. 2. As illustrated in FIG. 2, “Dress Pant” has values in the “Waist,” “Inseam,” and “Manufacturer” columns of “33,” “34,” and “Company A”, and has empty cells for the “Size” and “Insignia” Columns. Thus, if the “Running Shirt” record is selected, the “Waist” and “Inseam” columns are removed, and the values in those columns for the “Dress Pant” record are shifted under the column headers for the “Running Shirt” record. Specifically, “33” is shifted under the “Size” heading, and “34” is shifted under the “Insignia” heading. In one embodiment, “Company A” may also be shifted under the “Insignia” heading. This can occur if a particular column heading is wide enough to support more than one value. In this case, the “Insignia” field is wide enough to support both “34” and “Company A.” That is, each record may be displayed with all its valid cells, and the header is changed to match the cells of a selected row.

As illustrated, values that in other column headings may lose their visual context. That is, a user may not be able to ascertain the context for values of unselected records from column headings which they fall under. While visual context is lost, each value may still retain its actual context. For example, each value may have an associated metadata. The metadata may store the proper column heading that the value belongs. Thus, when a user selects another record, the metadata for each value in the newly-selected record may be examined to determine the column heading for each value. Once determined, a new dynamic contextual table header may be generated to reflect the columns of the newly selected record that include substantive data values.

FIGS. 3B-3C show the table after user selects another record from table 302. FIG. 3B illustrates a GUI screen 310 displaying another example of a dynamic contextual table header, according to one embodiment of the invention. Illustratively, the user has selected a record 314 storing data values for a “Dress Shirt.” The relevant columns for the record 312 include “Neck,” “Sleeve,” and “Manufacturer.” Accordingly, as shown in FIG. 3B, the table 312 reorders the columns of table 302 of FIG. 3A so that only the columns relevant to the selected “Dress Shirt” record 304 are displayed. At the same time, column headers containing empty cells for the “Dress Shirt” record 304 (e.g. “Size,” “Shape,” “Waist,” “Inseam,” and “Insignia) are not displayed.

FIG. 3C illustrates another GUI screen 320 displaying another example of a dynamic contextual table header, according to one embodiment of the invention, which presents a compacted table 322 to a user. Specifically, FIG. 3C shows a table 322 resulting from a user selection of a record 324 for a “Baseball Cap.” Illustratively, the relevant columns for the record 322 include “Size,” “Shape,” “Insignia,” and “Manufacturer.” Accordingly, as shown in FIG. 3C, the table 322 reorders the columns of table 312 of FIG. 3B so that only the columns relevant to the selected “Baseball cap” record 324 are displayed. At the same time column headers containing empty cells for the “Baseball cap” record 324 (e.g. “Neck,” “Sleeve,” “Shape,” “Waist,” and “Inseam”) are not displayed. As is shown in FIGS. 3A-3C, each time a user selects a different record, a new dynamic contextual table header is generated and displayed to provide context for the selected record.

In one embodiment, the GUI 122 may display a dynamic contextual table header near a selected record to improve the readability of a compacted table. This may be beneficial in cases where a table contains many records, making it difficult for the user to correlate a column header with a given row. For example, if a user scrolls down to view additional records, the column headers (which are generally located at the top of the table) may no longer be visible.

FIG. 4 illustrates a GUI screen 400 which presents a compacted table 402 with duplicate column headers, according to one embodiment of the invention. As shown, a GUI screen 400 presents a compacted table 402 where a user has selected the “Running Shirt” record 404. GUI 400 displays a duplicate column header 406 directly above the selected record 404. In one embodiment, a dynamic contextual table header may be inserted above a selected record 404. If a user selects a different record, the duplicate column header for the previously selected record is removed and a duplicate column header for the newly-selected record may be displayed.

In another embodiment, the duplicate column header may be provided as floating display or “mouse over” rendered on top of the table. As is known, a “mouse over” refers to a GUI event that occurs when a user “hovers” a cursor over a particular area of the GUI. Generally, the event may be the appearance of a small box with supplementary information regarding the item being “hovered” over. In this case, the item may be a record, and the supplementary information may be a dynamic contextual table header. In one embodiment, the header may appear directly above or below the selected record. Additionally, the appearance of the duplicate column header may occur after the cursor has “hovered” over a record for a specified amount of time.

In one embodiment, additional techniques may be used to improve readability of a compacted table. For example, the width of columns in a compacted table may be adjusted to align information between selected and unselected records. That is, columns that contain information for more than one record are aligned together. For example, FIG. 5 illustrates a GUI screen 500 which presents a compacted table 502 with aligned common column headers, according to one embodiment of the invention. As shown, the user has selected the “Running Shirt” record 504. And in response, a dynamic contextual table header 503 has been generated that includes the “Name,” “Size,” “Insignia,” and “Manufacturer” columns. Further, the table 502 has been compacted to present only these column headers.

As shown, each record contains a manufacturer name for an article of clothing (i.e. “Company A,” “Company B,” “Company C,” etc.). Further, the column widths of each record are adjusted so that the manufacturer names are aligned with the “Manufacturer” column header. For example, a record 506 “Running Shoes” includes a “Size” column stretched out to align the “Manufacturer” column of the record 506 with the column of record 504. Compare table 502 with table 402 of FIG. 4, where each record of table 402 contains a manufacturer name for the article of clothing, but the “Manufacturer” column for all the records have varying widths and thus, are not aligned with the “Manufacturer” column header. Note, in this example, the different widths occur because of the display order, not because there is any inherent different size of Company B, and Company D.

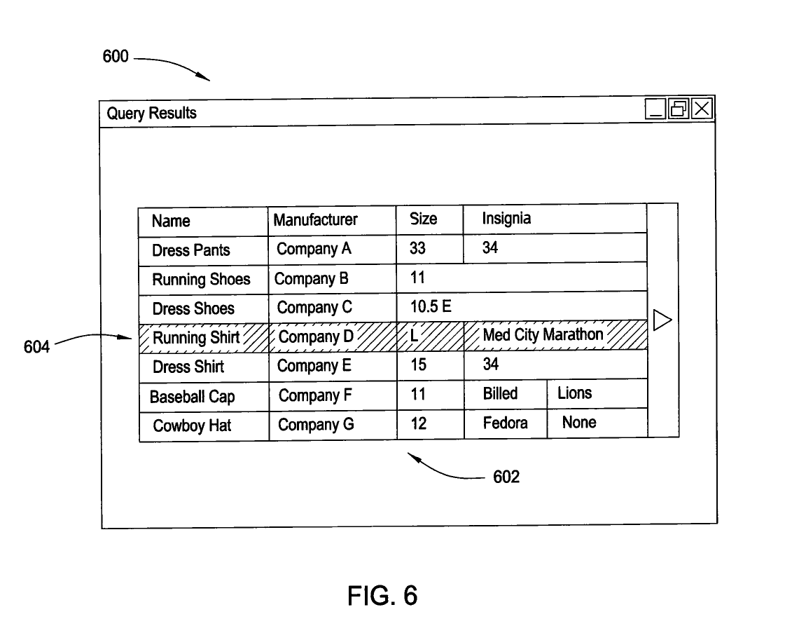

Embodiments of the invention may provide additional techniques to improve readability. For example, in addition to aligning common columns, the aligned common columns may also be re-ordered so that they are left-justified (or right-justified). That is, columns may be organized on one side of the table. For example, FIG. 6 illustrates a GUI screen 600 which presents a compacted table 602 with aligned common column headers, according to one embodiment of the invention. Similar to the table 502 illustrated in FIG. 5, the user has selected the “Running Shirt” record 504. Thus, the “Name,” “Size,” “Insignia,” and “Manufacturer” columns are displayed. However, as shown, all the aligned common columns are re-ordered so that they are left-justified. For example, common columns “Name” and “Manufacturer” (columns that contain information for all the records) are re-ordered so that they are both on the left side of the table 602. Further, the remaining columns which are not aligned (i.e. having varying column widths) may be re-ordered so they are organized at the end of the table.

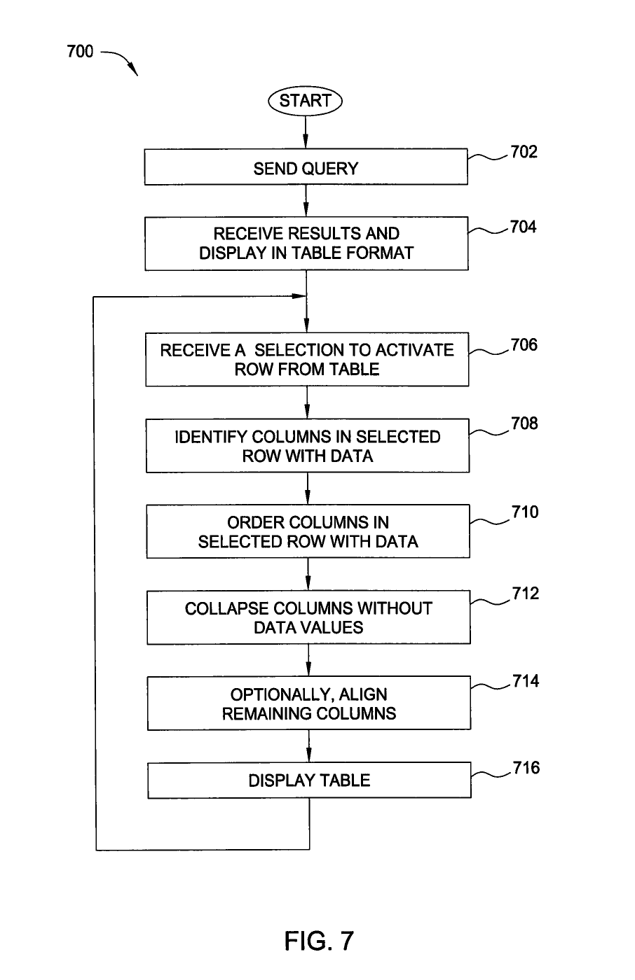

FIG. 7 is a flowchart illustrating a method 700 for generating and displaying dynamic contextual table headers, according to one embodiment of the invention. Persons skilled in the art will understand that any system configured to perform the method steps illustrated in FIG. 7, in any order, is within the scope of the present invention. As shown, the method 700 begins at step 702, where the application 120 requests a set of data records by sending a query to a data repository 150. At step 704, the application 120 may display results received from the data repository in a table format. At step 706, the application 120 may receive a selection to activate (or select) a record from the table via an input device 135. In one embodiment, the results may be displayed without a header indicating column headings until a user selects a row. Alternatively, the headers may correspond to the columns of the first row. For example, when the table is generated as a result of joining disparate columns from multiple tables, the header may simply present the selected columns of that table.

Once a record is activated, however, a dynamic contextual table header may be generated. As the examples above illustrate, the dynamic contextual table header may include column headers for each column of the selected record that stores a substantive data value. Further, the table may be re-formatted to only display columns of the table relevant to the activated record. In one embodiment, the table may already be compacted before a user activates a record. In this case, the table may be compacted to reflect the first record of the table. In other words, the table may default to the first record being selected.

In one embodiment, the application 120 may identify which columns are relevant to the activated record to determine which column headers and associated columns to display. At step 708, the application 120 may search for columns in the selected record that contain data (i.e. integer, character, string, etc.) Those columns containing data may be considered relevant for the selected record. Optionally, the columns may be aligned such that column widths match across all records of the table. At step 710, once the relevant columns and column headers are determined, the application 120 may reorder the columns for the table so that the relevant columns are organized next to each other. In one embodiment, the columns not having any data for the selected record may be moved to one end of the table. In addition, at step 712, the application 120 may also collapse the table so that only the relevant columns are shown to the user.

In one embodiment, once the table has been re-ordered, the portions of the table may be aligned so that columns that are common between selected and unselected records (that is, columns that contain information for more than one record) are aligned relative to the column headers (as discussed above with reference to FIG. 5). At step 716, once the table is formatted, the application 120 may display the table to the user. Subsequently, the method returns to step 706, where record selections for the newly-formatted table may be received.

As the examples presented herein illustrate, a table containing a plurality of records may be compacted to save space, while still preserving context for the records stored in the table. Furthermore, the table may be re-formatted every time a user selects a new record, where the newly-formatted table dynamically displays contextual table headers for the selected record.

While the foregoing is directed to embodiments of the present invention, other and further embodiments of the invention may be devised without departing from the basic scope thereof, and the scope thereof is determined by the claims that follow.

What is claimed is:

1. A computer-implemented method of presenting data records, comprising:
displaying a plurality of records in a table, wherein the table includes a plurality of columns, wherein each record is displayed in a row of the table, and wherein each record includes data values for one or more of the columns of the table;
receiving a selection of one of the records of the table;
identifying which columns of the selected record include data values;
generating a table header that includes a label for each of the identified columns; and
displaying the table header.

2. The method of claim 1, further comprising, prior to displaying the table header, collapsing the display of the table to remove columns which do not include data vales for the selected record.

3. The method of claim 1, further comprising, prior to displaying the table header, reordering the columns to group the identified columns together.

4. The method of claim 1, wherein the table header is displayed as a first row of the table.

5. The method of claim 1, wherein the table header is displayed proximate to the selected row.

6. The method of claim 5, wherein the table header is displayed in response to a mouse cursor hovering over the selected row for a pre-defined period of time.

7. The method of claim 5, wherein the table header is displayed in response to an eye tracker device focusing over the selected row for a pre-defined period of time.

8. The method of claim 7, wherein the selected record remains selected and the table header remains displayed if the eye tracker device changes focus from the selected record for a duration that does not exceed a predetermined threshold.

9. The method of claim 1, further comprising, aligning a column width of at least one column of a row other than the selected row, with a column width of at least one column of the selected row.

10. The method of claim 1, wherein metadata associated with each respective data value of the selected record identifies the label to use in the table header.

11. A computer-readable storage medium containing a program which, when executed, performs an operation for presenting a display of data records, comprising:
displaying a plurality of records in a table, wherein the table includes a plurality of columns, wherein each record is displayed in a row of the table, and wherein each record includes data values for one or more of the columns of the table;
receiving a selection of one of the records of the table;
identifying which columns of the selected record include data values;
generating a table header that includes a label for each of the identified columns; and
displaying the table header.

12. The computer-readable storage medium of claim 11, wherein the operation further comprises, prior to displaying the table header, collapsing the display of the table to remove columns which do not include data vales for the selected record.

13. The computer-readable storage medium of claim 11, wherein the operation further comprises, prior to displaying the table header, reordering the columns to group the identified columns together.

14. The computer-readable storage medium of claim 11, wherein the table header is displayed as a first row of the table.

15. The computer-readable storage medium of claim 11, wherein the table header is displayed proximate to the selected row.

16. The computer-readable storage medium of claim 15, wherein the table header is displayed in response to a mouse cursor hovering over the selected row for a pre-defined period of time.

17. The computer-readable storage medium of claim 11, wherein the operation further comprises, aligning a column width of at least one column of a row other than the selected row, with a column width of at least one column of the selected row.

18. The computer-readable storage medium of claim 11, wherein metadata associated with each respective data value of the selected record identifies the label to use in the table header.

19. A system, comprising:
a processor; and
a memory containing a program, which when executed by the processor, is configured to perform an operation for presenting a display of data records, the operation comprising the steps of:
displaying a plurality of records in a table, wherein the table includes a plurality of columns, wherein each record is displayed in a row of the table, and wherein each record includes data values for one or more of the columns of the table,
receiving a selection of one of the records of the table,
identifying which columns of the selected record include data values,
generating a table header that includes a label for each of the identified columns, and
displaying the table header.

20. The system of claim 19, further comprising, prior to displaying the table header, collapsing the display of the table to remove columns which do not include data vales for the selected record.

21. The system of claim 19, wherein the steps further comprise prior to displaying the table header, reordering the columns to group the identified columns together.

22. The system of claim 19, wherein the table header is displayed as a first row of the table.

23. The system of claim 19, wherein the table header is displayed proximate to the selected row.

24. The system of claim 23, wherein the table header is displayed in response to a mouse cursor hovering over the selected row for a pre-defined period of time.

25. The system of claim 19, wherein the steps further comprise, aligning a column width of at least one column of a row other than the selected row, with a column width of at least one column of the selected row.

26. The system of claim 19, wherein metadata associated with each respective data value of the selected record identifies the label to use in the table header.
